(19) United States
(12) Patent Application Publication
(10) Pub. No.: US 2025/0173663 A1
(43) Pub. Date: May 29, 2025

(54) Secure Communication Systems for Case Inventory

(71) Applicant: Teton Litware LLC, Wilmington, DE (US)

(72) Inventor: Donald C. Discepolo, Fulton, MD (US)

(21) Appl. No.: 18/523,672

(22) Filed: Nov. 29, 2023

(51) Int. Cl. G06Q 10/0639; G06F 21/10; G06Q 40/08; G06Q 50/18

(52) U.S. Cl. CPC G06Q 10/06393; G06F 21/1014; G06Q 40/08; G06Q 50/18

(57) ABSTRACT

A secure communication system is disclosed. Embodiments include automatically convert, using at least one processor and in response to the first feedback loop, the evaluation scores to updated evaluation scores. Embodiments include receive, using at least one processor coupled to memory, a second feedback loop from a third user in response to providing the updated evaluation scores to the third user. Embodiments include automatically convert, in response to the second feedback loop, the updated evaluation scores to transformed evaluation scores. Embodiments include provide one or more actions to at least one of the first user, the second user, and the third user based on the transformed evaluation scores and the clusters of similar variables, execution by at least one of the first user, the second user, and the third user of at least one of the one or more actions increasing at least one of the transformed evaluation scores.

### FIELD OF THE TECHNOLOGY

The present technology relates generally to secure communication, and more particularly, but not by limitation, to systems for secure communication between users that allow latency remediation and for evaluating opportunities.

### BACKGROUND

The field of secure communication systems has seen significant advancements in recent years, particularly in the context of data management and predictive analytics. These systems are integral to a wide range of industries and applications, from finance and healthcare to defense and e-commerce. They enable the secure transmission, storage, and analysis of sensitive information, thereby protecting the integrity of the data and the privacy of the users.

Previous approaches to secure communication systems may lack the ability to provide real-time actions based on transformed evaluation scores and clusters of similar variables. These systems may not have the capability to automatically generate and execute actions that can increase the transformed evaluation scores. As a result, the decision-making process may be slower and less efficient, leading to missed opportunities and decreased overall performance.

Another significant challenge is the security of the data. The sensitive nature of the information often involved in these systems necessitates robust security measures to protect against potential threats. However, existing implementations often fall short in providing the necessary level of security, exposing users to potential risks.

None of the previous approaches have provided a comprehensive technological solution that combines the features described in this disclosure. The present technology addresses these limitations by providing a secure communication system that integrates user interface, data management, predictive analytics, and application server functionalities. The system enables efficient processing and evaluation of opportunities by comparing variables, identifying clusters of similar variables, and automatically converting evaluation scores based on user feedback. Furthermore, the system offers real-time actions based on transformed evaluation scores and clusters of similar variables, enhancing the decision-making process, and maximizing the potential for increased value for users.

### SUMMARY OF THE PRESENT TECHNOLOGY

According to some embodiments, the present technology relates to a secure communication system configured by at least one processor to execute instructions stored in memory, the secure communication system including: a user interface for receiving input variables from a first user; a data management system including a database server for storing the input variables; a predictive analytics system; a platform providing a web services layer that provides access to the user interface, the data management system, and the predictive analytics system, the platform further providing an application server layer configured to: provide a user-facing application using the user interface and access the data management system and the predictive analytics system using the web services layer; perform processing using one or more of the input variables and user interaction with an evaluation application, the processing using at least one processor to execute instructions stored in memory to: for each of a plurality of opportunities, receive a set of variables that are indicative of attributes of the plurality of opportunities; compare the set of variables for the plurality of opportunities to each other and to historical opportunities with the set of variables and known outcomes, and to one or more of the input variables; locate clusters of similar variables shared between one or more of the plurality of opportunities and the historical opportunities with the set of variables and the known outcomes and shared between one or more of the input variables; calculating a distinction score for each of the plurality of opportunities that represents a degree of difference of the plurality of opportunities to one another and the historical opportunities with the set of variables and the known outcomes based on shared variables that are shared between the plurality of opportunities and the historical opportunities with the set of variables and the known outcomes and using one or more of the input variables; calculate evaluation scores that represent a range of values for each of the plurality of opportunities based on the distinction score for each of the plurality of opportunities and based on the historical opportunities with the set of variables and the known outcomes and using one or more of the input variables; receive, using at least one processor coupled to memory, a first feedback loop from a second user in response to providing the evaluation scores to the second user; automatically convert, using at least one processor and in response to the first feedback loop, the evaluation scores to updated evaluation scores; receive, using at least one processor coupled to memory, a second feedback loop from a third user in response to providing the updated evaluation scores to the third user; automatically convert, using at least one processor, and in response to the second feedback loop, the updated evaluation scores to transformed evaluation scores; and provide one or more actions to at least one of the first user, the second user, and the third user based on the transformed evaluation scores and the clusters of similar variables, execution by at least one of the first user, the second user, and the third user of at least one of the one or more actions increasing at least one of the transformed evaluation scores.

In some embodiments, the techniques described herein relate to a secure communication system, wherein the user-facing application is secured through use of a security token cached on a web browser, the web browser providing the user-facing application.

In some embodiments, the techniques described herein relate to a secure communication system, further including the data management system and the predictive analytics system are located in secure isolation from a remainder of the secure communication system.

In some embodiments, the techniques described herein relate to a secure communication system, wherein the first user is a legal entity, the legal entity having a portfolio of litigation cases.

In some embodiments, the techniques described herein relate to a secure communication system, wherein the second user includes an insurance entity, the insurance entity including one or more of an insurance provider, a reinsurance entity, a rating agency, and an insurance broker.

In some embodiments, the techniques described herein relate to a secure communication system, further including comparing, by the insurance entity using at least one processor, the transformed evaluation scores to an insurance risk threshold; wherein the first feedback loop from the insurance entity includes a decrease of the insurance risk threshold of the insurance entity; and automatically converting, in response to the decrease of the insurance risk threshold of the insurance entity, the updated evaluation scores to include at least one decreased updated evaluation score.

In some embodiments, the techniques described herein relate to a secure communication system, further including comparing, by the insurance entity using at least one processor, the transformed evaluation scores to an insurance risk threshold; wherein the first feedback loop from the insurance entity includes an increase of the insurance risk threshold of the insurance entity; automatically converting, in response to the increase of the insurance risk threshold of the insurance entity, the updated evaluation scores to include at least one increased updated evaluation score.

In some embodiments, the techniques described herein relate to a secure communication system, wherein the third user is an investment entity.

In some embodiments, the techniques described herein relate to a secure communication system, further including comparing, by the investment entity using at least one processor, the transformed evaluation scores to an investment risk threshold; wherein the second feedback loop from the investment entity in response to providing the updated evaluation scores to the investment entity includes a decrease of the investment risk threshold of the investment entity; automatically converting, in response to the decrease of the investment risk threshold of the investment entity, the updated evaluation scores to include at least one decreased transformed evaluation scores.

In some embodiments, the techniques described herein relate to a secure communication system, further including comparing, by the investment entity using at least one processor, the transformed evaluation scores to an investment risk threshold; wherein the second feedback loop from the investment entity in response to providing the updated evaluation scores to the investment entity includes an increase of the investment risk threshold of the investment entity; automatically converting, in response to the increase of the investment risk threshold of the investment entity, the updated evaluation scores to include at least one increased transformed evaluation scores.

In some embodiments, the techniques described herein relate to a secure communication system, wherein the input variables from the first user include inputs from a law firm, the inputs from the law firm including one or more of an inventory of litigation cases, statement documents of the law firm, a requested loan amount, a loan to value ratio, the loan to value ratio being a comparison of the requested loan amount compared with collateral provided to secure the requested loan amount.

In some embodiments, the techniques described herein relate to a secure communication system, wherein the plurality of opportunities include one or more of a lawsuit and an arbitration proceeding.

In some embodiments, the techniques described herein relate to a secure communication system, wherein the set of variables include one or more of a court docket item, a settlement, a verdict, and a legal update.

In some embodiments, the techniques described herein relate to a secure communication system, wherein the known outcomes includes at least a known settlement amount.

In some embodiments, the techniques described herein relate to a secure communication system, wherein a distinction score for each of the plurality of opportunities that represents a degree of difference of the plurality of opportunities to one another and the historical opportunities includes a

In some embodiments, the techniques described herein relate to a secure communication system, wherein the evaluation scores represent a range of values for each of the plurality of opportunities.

In some embodiments, the techniques described herein relate to a secure communication system, wherein the first feedback loop includes receiving real-time updates from an insurance entity; and wherein the processing using at least one processor to execute instructions stored in memory to further includes: in response to the real-time updates from the insurance entity, automatically convert, using at least one processor, the updated evaluation scores to real-time updated evaluation scores

In some embodiments, the techniques described herein relate to a secure communication system, wherein the second feedback loop includes receiving real-time updates from an investment entity; and wherein the processing using at least one processor to execute instructions stored in memory to further includes: in response to the real-time updates from the investment entity, automatically convert, using at least one processor, and in response to the real-time updates from the investment entity, the transformed evaluation scores to real-time transformed evaluation scores.

In some embodiments, the techniques described herein relate to a method, including: for each of a plurality of opportunities, receive a set of variables that are indicative of attributes of the plurality of opportunities; compare the set of variables for the plurality of opportunities to each other and to historical opportunities with the set of variables and known outcomes, and to one or more of input variables; locate clusters of similar variables shared between one or more of the plurality of opportunities and the historical opportunities with the set of variables and the known outcomes and shared between one or more of the input variables; calculating a distinction score for each of the plurality of opportunities that represents a degree of difference of the plurality of opportunities to one another and the historical opportunities with the set of variables and the known outcomes based on shared variables that are shared between the plurality of opportunities and the historical opportunities with the set of variables and the known outcomes and using one or more of the input variables; calculate evaluation scores that represent a range of values for each of the plurality of opportunities based on the distinction score for each of the plurality of opportunities and based on the historical opportunities with the set of variables and the known outcomes and using one or more of the input variables; receive, using at least one processor coupled to memory, a first feedback loop from a second user in response to providing the evaluation scores to the second user; automatically convert, using at least one processor and in response to the first feedback loop, the evaluation scores to updated evaluation scores; receive, using at least one processor coupled to memory, a second feedback loop from a third user in response to providing the updated evaluation scores to the third user; automatically convert, using at least one processor, and in response to the second feedback loop, the updated evaluation scores to transformed evaluation scores; and provide one or more actions to at least one of a first user, the second user, and the third user based on the transformed evaluation scores and the clusters of similar variables, execution by at least one of the first user, the second user, and the third user of at least one of the one or more actions increasing at least one of the transformed evaluation scores.

In some embodiments, the techniques described herein relate to a secure communication system of claim, including: at least one processor; and a memory for storing executable instructions, the at least one processor executing the executable instructions to: for each of a plurality of opportunities, receive a set of variables that are indicative of attributes of the plurality of opportunities; compare the set of variables for the plurality of opportunities to each other and to historical opportunities with the set of variables and known outcomes, and to one or more of input variables; locate clusters of similar variables shared between one or more of the plurality of opportunities and the historical opportunities with the set of variables and the known outcomes and shared between one or more of the input variables; calculating a distinction score for each of the plurality of opportunities that represents a degree of difference of the plurality of opportunities to one another and the historical opportunities with the set of variables and the known outcomes based on shared variables that are shared between the plurality of opportunities and the historical opportunities with the set of variables and the known outcomes and using one or more of the input variables; calculate evaluation scores that represent a range of values for each of the plurality of opportunities based on the distinction score for each of the plurality of opportunities and based on the historical opportunities with the set of variables and the known outcomes and using one or more of the input variables; receive, using at least one processor coupled to memory, a first feedback loop from a second user in response to providing the evaluation scores to the second user; automatically convert, using at least one processor and in response to the first feedback loop, the evaluation scores to updated evaluation scores; receive, using at least one processor coupled to memory, a second feedback loop from a third user in response to providing the updated evaluation scores to the third user; automatically convert, using at least one processor, and in response to the second feedback loop, the updated evaluation scores to transformed evaluation scores; and provide one or more actions to at least one of a first user, the second user, and the third user based on the transformed evaluation scores and the clusters of similar variables, execution by at least one of the first user, the second user, and the third user of at least one of the one or more actions increasing at least one of the transformed evaluation scores.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of a computing architecture, according to various embodiments of the present technology.

FIG. 2A is a diagram of a secure communication system, according to various embodiments of the present technology.

FIG. 2B is a continuation of the diagram of the secure communication system, according to various embodiments of the present technology.

FIG. 3 is a flowchart of an exemplary method, according to various embodiments of the present technology.

FIG. 4 illustrates an exemplary computing system that may be used to implement embodiments, according to various embodiments of the present technology.

### DETAILED DESCRIPTION

Generally speaking, the present technology provides secure communication platforms. These secure communication platforms advantageously implement secure messaging features and latency compensation features which allow the user to have an uninterrupted and secure user experience. Users may interact with a secure communication platform of the present technology securely and without latency. Various operations may require data intensive operations by a backend system in response to user inputs. These compute intensive operations, but for the solutions described herein, would result in latency or other similar deleterious effects that would decrease the user experience.

In some embodiments, secure communication platforms may be built upon existing third-party systems or services and can provide secure access and messaging into and out of these third-party systems and services. The security features described herein may isolate both system components and data from unauthorized access.

A problem is the field is that there is no uniform application process that is secure for litigation finance loans. Other industries, like the residential mortgage market, have a uniform process for the loan process. In other words, a problem that exists is that whenever a plurality of opportunities for litigation funding are presented to an investor (e.g., a hedge fund or a litigation finance company), there is no secure uniform process to evaluate the plurality of opportunities and to securely compare the plurality of opportunities. For example, different types of information are requested by different evaluators resulting in valuations made by different evaluators disjunctive. In other words, valuations made by different evaluators are not uniform or secure and are difficult to compare and evaluate. For example, if the same loan opportunity is evaluated by three different evaluators or investors (e.g., hedge funds or litigation finance companies), each of the three different evaluators require three different types of information for their individual process and each of the three different evaluators output with three different evaluations that are not secure. Thus, from a loan application standpoint, there is a need to have a uniform application process using a secure communication platform where applicants for litigation funding may use the secure communication platform and evaluators or investors (e.g., hedge funds or litigation finance companies) may use the secure communication platform to securely evaluate the opportunities and securely choose an opportunity that matches the needs of the investor. In other words, brokers are eliminated and a uniform and secure communication platform is used to evaluate opportunities resulting in the elimination of brokers in the loan process. Accordingly, the secure communication platform of the present technology may use algorithms to analyze and evaluate case inventory and valuation that is based on historical data and may value any type of new opportunity based on prior settlements. For example, prior settlements may be of mass torts over the past twenty years. For instance, the secure communication platform of the present technology may price and value an inventory of opportunities to give a value per opportunity or case. For example, a loan to value from that perspective may be established for each opportunity of the inventory of opportunities.

In various embodiments, the secure communication platform receives input variables from a first user (such as a law firm). For example, the input variables may include law firm inventory, the statement documents of the law firm, and a requested loan amount, the requested loan amount including loan to value (LTV), and litigation data.

In some embodiments, the law firm inventory includes of all of the cases of the law firm. For instance, a law firm may provide the inventory of their cases. For example, the litigation matters of the law firm that are presently seeking litigation funding. In some instances, the law firm inventory may be a specific subset of the inventory that the law firm is seeking to collateralize with a loan. Accordingly, the secure communication platform may securely receive case inventory from an entity.

In some embodiments, the statement documents of the law firm include financial documents of the law firm. For example, the last three years of tax returns for the law firm, statements gross profits of the law firm, statements of expenses of the law firms, statements of the net profit of the law firm, statement of overhead of the law firm, statement of case acquisition, statement of court costs and filings, statement of expenses for experts, and the like.

In some embodiments, the requested loan amount includes the loan to value (LTV). For example, the loan amount requested may be how much of a loan is the law firm requesting. Furthermore, the loan to value (LTV) may be determined by a value of their collateral provided by the law firm compared with the loan amount requested. For example, the LTV may be used by the evaluators to determine whether or not the evaluators (e.g., hedge fund or litigation finance company) invest in an opportunity or not.

In some embodiments, for each of a plurality of opportunities, the present technology receives a set of variables that are indicative of attributes of the plurality of opportunities. For example, the set of variables may include litigation data including data of settlements, court dockets, lawsuit settlements, lawsuit verdicts. For example, the set of variables for opportunities (such as litigation finance opportunities) may include litigation data such as an average settlement for a past sexual abuse filed against an organization such as a Church entity, school district, government entity, and so forth. Litigation data further includes daily legislative slip sheets, and legislative updates such as the Department of the Navy just issuing a settlement grid for Camp Lejeune Water Lawsuits. For example, Camp Lejeune Water Lawsuits case updates regarding contaminated drinking water at North Carolina's U.S. Marine Core Base Camp Lejeune that put hundreds of thousands of people at risk for cancer and other serious illnesses. Between 1953 and 1987, two of the eight wells at Camp Lejeune were contaminated with harmful chemicals known to cause cancer and other severe illnesses. These wells supplied contaminated drinking water to children at daycare or school, to military families for drinking and bathing, to patients in the hospital, and to service members and civilian workers in their place of employment. Fifteen different illnesses and medical conditions including several types of cancer, reproductive problems, birth defects, and Parkinson's disease have been linked to Camp Lejeune water contamination lawsuits. For example, an opportunity may be an average case settlement for a plaintiff with a categorized profile for a Camp Lejeune Water Lawsuit.

Litigation data further includes updated facts regarding the litigation data such as Boy Scouts of America going into bankruptcy or different Catholic dioceses going into bankruptcy and how the updated facts effect the settlement value of a case matter. Furthermore, updated facts further monitoring of the payouts (e.g., case settlements) for each litigation matter.

In some embodiments, outputs generated by the secure communication platform 200 a range in values for each case. Outputs further include a confidence number on how accurate the ranges in values for each case.

According to some embodiments, the systems and methods herein implement security layers (provided by the secure communication platform 200) that utilize Secure Socket Layer (SSL) and encryption. These features, in addition to the token-based transaction features described below, provide solutions to problems that arise in extensible or modular computing environments, where systems are built on existing third party resources.

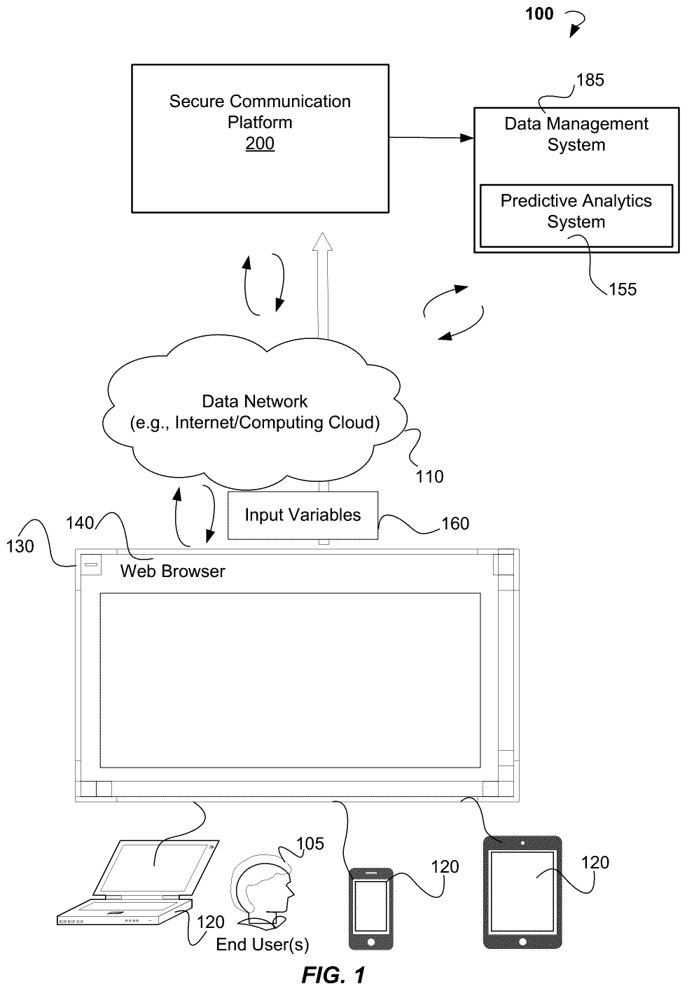

Referring now to the drawings, FIG. 1 illustrates an environment 100 within which systems and methods for providing secure communication can be implemented. The environment 100 may include a data network 110 (e.g., an Internet or a computing cloud), end user(s) 105 (e.g., lawyer(s)), client device(s) 120 (also referred to herein as user devices) associated with the end user(s) 105 (e.g., lawyer(s)) (also referred to herein as users), and the secure communication platform 200 for providing secure communication. Client device(s) 120 may include a personal computer (PC), a desktop computer, a laptop, a smartphone, a tablet, or so forth.

For example, a client device of the client device(s) 120 may have a user interface 130. Furthermore, a web browser 140 may be running on the client device of the client device(s) 120 and displayed using the user interface 130. The web browser 140 may communicate with the secure communication platform 200 via the data network 110.

The data network 110 may include the Internet or any other network capable of communicating data between devices (e.g., client device(s) 120). Suitable networks may include or interface with any one or more of, for instance, a local intranet, a corporate data network, a data center network, a home data network, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network 110 can further include or interface with any one or more of a Recommended Standard 232 (RS-232) serial connection, an IEEE-1394 (Fire Wire) connection, a Fiber Channel connection, an IrDA (infrared) port, a Small Computer Systems Interface connection, a Universal Serial Bus (USB) connection or other wired or wireless, digital, or analog interface or connection, mesh or Digi® networking.

The secure communication platform 200 can receive input variables 160 for a plurality of objects. The plurality of objects may include data objects (e.g., an opportunity of a plurality of opportunities), persons, such as end user(s) 105 (e.g., a first user, a second user, and a third user), and hardware, such as applications running on the client device(s) 120. Based on the input variables 160, the secure communication platform 200 may create evaluation scores for the plurality of objects and incorporate feedback loops into the evaluation scores that represent a range of values for each of the plurality of opportunities using the data management system 185 and the predictive analytics system 155.

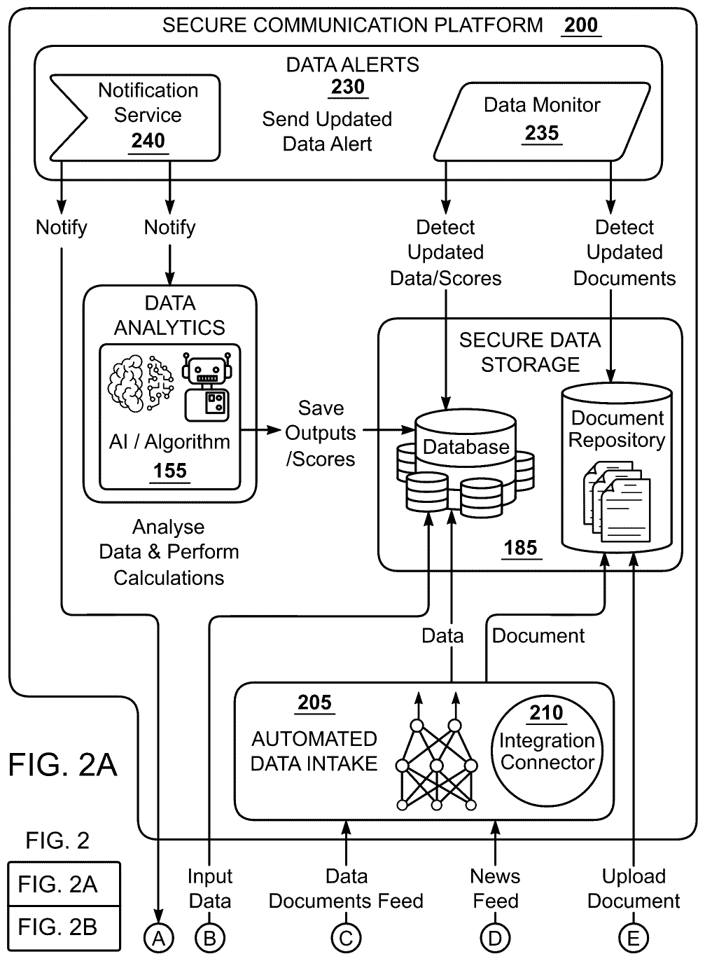

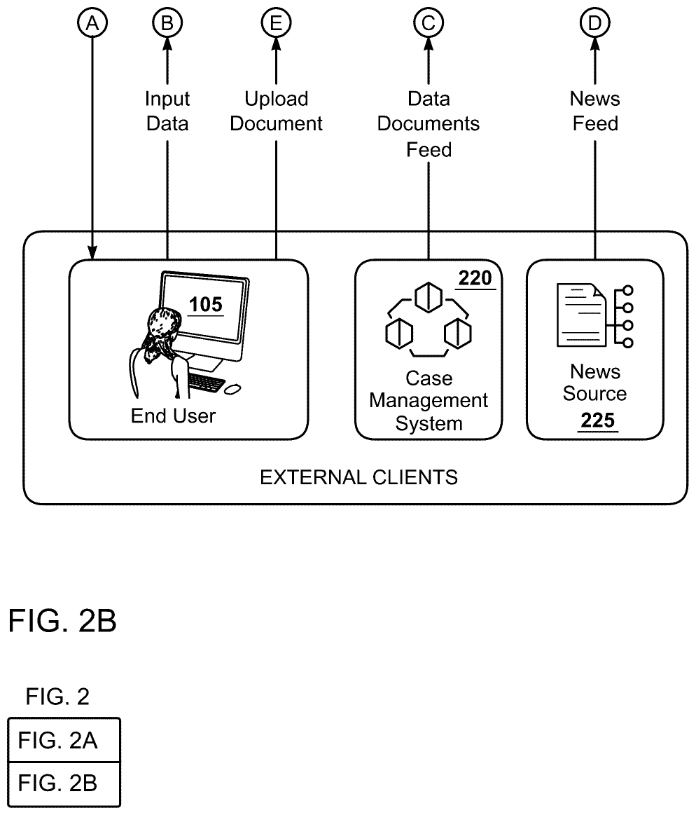

FIG. 2A is a diagram of a secure communication system, according to various embodiments of the present technology. FIG. 2B is a continuation of the diagram of the secure communication system, according to various embodiments of the present technology. FIG. 2A shows automated data intake 205 and data aggregation using an integration connector 210 that is received from external clients (end user(s) 105 (e.g., lawyers, investors, and insurers)). As shown in FIG. 2B, end user(s) 105 (e.g., lawyers, investors, and insurers) input data into database via user interface (e.g., user interface 130). For example, an end user (e.g., lawyer) uploads documents into document repository via the user interface (e.g., user interface 130). For example, the integration connector 210 automatically uploads documents and data from case management system 220 into document repository and database. Furthermore, the integration connector 210 automatically uploads documents and data from a news source 225 (e.g., including a case docket and court dockets) into the data management system 185 that allows for secure data storage including a document repository and secure database.

According to various embodiments, the automated data intake 205 and data aggregation using the integration connector 210 solve a problem in the field. Data intake and aggregation was done via slow, insecure, and error prone manual file sharing processes. Critical real-time data may be entirely neglected due to the arduous process of manually identifying and uploading relevant documents. The automated data intake 205 and data aggregation using the integration connector 210 and using the secure communication platform 200 utilizes simple, secure, and performant user interfaces (e.g., user interface 130) and the integration connector 210 to provide data and document intake capabilities, which automatically detect, upload, and aggregate relevant data and documents.

According to further embodiments, FIG. 2A further shows data alerts 230. For example, a data monitor 235 automatically detects updated data and analytics/scores in a database (e.g., data management system). For example, the data monitor 235 automatically detects updated documents in a document repository of the data management system (e.g., data management system 185). In some instances, the data monitor 235 sends automated data alerts to notification service 240 for broadcast to notification subscribers (e.g., lawyers). For example, the data monitor 235 solves the problems of notifications of updated data and analytics to interested clients (i.e., end user(s) 105 (e.g., lawyers, investors, and insurers)) was done via slow, manual notification, causing long response cycles that lead to missed business opportunities, stale data, wasted time, and wasted resources. For example, the secure communication platform 200 of the present technology using the data monitor 235 utilizes a flexible data monitoring function that automatically detects the availability of new or updated data and automatically notifies interested parties (i.e., end user(s) 105 (e.g., lawyers, investors, and insurers)) via direct, secure, and fast communication services. This enables the automatic, real-time analysis of newly updated data and documents and a feedback loop of real-time data notifications to end users (i.e., end user(s) 105 (e.g., lawyers, investors, and insurers)), allowing the users (i.e., end user(s) 105 (e.g., lawyers, investors, and insurers)) to immediately act upon the updated data in real time, while the data is fresh and accurate, and capture potential business opportunities provided by the data analysis.

According to further embodiments, FIG. 2A further shows data analytics using a predictive analytics system 155 that uses Artificial Intelligence (AI) and predictive algorithms to generate notifications to subscribers (i.e., end user(s) 105 (e.g., lawyers, investors, and insurers)) and receive alerts for updated data and documents from the notification service 240 using a notification server. AI and algorithms using the predictive analytics system 155 of the present technology automatically perform calculations and analytics. Furthermore, AI and algorithms of the present technology automatically send outputs (e.g., scores) to the data management system 185 for storage. For example, a problem exists because analysis of data to provide analytics, metrics, valuations, and scores is a slow, arduous, costly, and error-prone manual process that leads to missed business opportunities, stale data, wasted time, and wasted resources. For example, the secure communication platform 200 of the present technology utilizes sophisticated algorithms and artificial intelligence systems (e.g., Large Language Models of the predictive analytics system 155) to automatically analyse aggregated data sets and perform rapid calculations, providing analytics, metrics, valuations, and scores in near real-time, while the data is fresh and accurate, allowing interested parties to act immediately according to outputs.

According to further embodiments, the secure communication platform 200 of the present technology utilizes one or more end user feedback loop(s). For example, end user(s) 105 (e.g., notification subscriber(s)) (i.e., end user(s) 105 (e.g., lawyers, investors, and insurers)) may receive alerts for updated data and documents from notification service 240. For example, a problem exists that the current cycle time for end user(s) 105 (e.g., lawyers, investors, and insurers) to receive updated analytics is extremely slow, leading to missed business opportunities, stale data, wasted time, and wasted resources. The secure communication platform 200 of the present technology includes a technical solution that by utilizing, the mechanisms described herein (e.g., automated data intake 205 and aggregation, data alerts sent by the data monitor 235, and data analytics (e.g., predictive analytics system 155)), a complete automated, and near real-time feedback loop is established, enabling end users (i.e., end user(s) 105, e.g., lawyers, investors, and insurers) to receive and act upon relevant data analytics, allowing them to capture business opportunities, while minimizing cycle times, costs, and effort.

According to further embodiments, the secure communication platform 200 of the present technology utilizes encryption and security for data storage and data transmission. For example, data management system 185 may store data and documents in databases and document repositories. For example, data and documents are transmitted from end user(s) 105 (e.g., lawyers, investors, and insurers) to data storage via Secure Socket Layer (SSL) transmission that utilize and encryption. Additionally, for example, data storage systems are protected by security monitoring tools and data and documents in data storage systems (i.e., data management system 185) are encrypted at rest.

FIG. 1, FIG. 2A, and FIG. 2B illustratively shows a secure communication system according to the present technology. The system comprises a user interface (e.g., user interface 130), data management system 185, the predictive analytics system 155, a web services layer (provided by the secure communication platform 200), and an application server layer (provided by the secure communication platform 200). The user interface 130 receives input variables (e.g., input variables 160) from a first user. The data management system 185 stores the input variables (e.g., input variables 160) in a database server. The predictive analytics system 155 is used to compare the set of variables for the plurality of opportunities to each other and to historical opportunities with the set of variables and known outcomes, and to one or more of the input variables (e.g., input variables 160). The web services layer (provided by the secure communication platform 200) provides access to the user interface (e.g., user interface 130), the data management system 185, and the predictive analytics system 155. The application server layer (provided by the secure communication platform 200) is configured to provide a user-facing application using the user interface (e.g., user interface 130) and access the data management system 185 and the predictive analytics system 155 using the web services layer (provided by the secure communication platform 200).

According to some embodiments, FIG. 1 illustratively shows a secure communication system according to the present technology. The system comprises a user interface (e.g., user interface 130), a data management system (e.g., data management system 185), a predictive analytics system 155, a web services layer (provided by the secure communication platform 200), and an application server layer (provided by the secure communication platform 200). The application server layer (provided by the secure communication platform 200) is configured to receive input variables (e.g., input variables 160) from the first user via the user interface (e.g., user interface 130), access the data management system 185 and predictive analytics system 155 using the web services layer (provided by the secure communication platform 200), perform processing using one or more of the input variables (e.g., input variables 160) and user interaction with an evaluation application, calculate distinction scores for each of the plurality of opportunities based on shared variables (e.g., input variables 160) between them and historical opportunities with known outcomes, calculate evaluation scores based on the distinction scores and historical opportunities with known outcomes, receive feedback loops from second and third users in response to providing evaluation scores to them, automatically convert evaluation scores in response to feedback loops received from second and third users, and provide one or more actions to at least one of first user, second user or third user based on transformed evaluation scores and clusters of similar variables. Execution by at least one of first user, second user or third user of at least one of the one or more actions increases at least one of transformed evaluation scores.

According to various embodiments, advantageously, the secure communication system provides a comprehensive solution to the problem of lack of a uniform and secure application process for litigation finance loans. The system's user interface (e.g., user interface 130) is designed with a user-friendly layout and intuitive controls, allowing the first user, who could be connected to a legal entity such as a law firm or a corporation with a portfolio of litigation cases, to input variables (e.g., input variables 160) with ease. These variables could include a detailed inventory of the law firm's ongoing and potential litigation cases, including the nature of each case, the stage of litigation, the expected duration, and the potential damages or settlement amounts. Financial documents of the law firm, such as balance sheets, income statements, cash flow statements, and tax returns, can also be inputted. These documents provide a comprehensive view of the law firm's financial health, including its assets, liabilities, revenues, expenses, and cash flows. This information is crucial for assessing the law firm's ability to repay the litigation finance loan. The requested loan amount, which includes the loan to value (LTV), is another important variable. The loan to value ratio is a financial metric that compares the amount of the loan requested by the law firm to the value of the collateral that the law firm is willing to provide to secure the loan. This ratio is a key indicator of the riskiness of the loan. Litigation data, such as the historical success rate of the law firm in similar cases, the average settlement amounts or damages awarded in similar cases, and the average duration of similar cases, can also be inputted. This data provides valuable insights into the potential return on investment of the litigation finance loan. The data management system 185 and predictive analytics system 155, accessed via the web services layer (provided by the secure communication platform 200), process these variables (e.g., input variables 160) and user interaction (user interaction from e.g., end user(s) 105 (e.g., lawyers, investors, and insurers) with an evaluation application. The data management system 185 organizes and stores the inputted variables (e.g., input variables 160) in a structured and searchable format, facilitating efficient data retrieval and analysis. The predictive analytics system 155 uses advanced algorithms and machine learning techniques to analyze and evaluate the case inventory and valuation based on historical data, such as prior settlements of mass torts over the past twenty years. The system calculates distinction scores for each opportunity based on shared variables (e.g., input variables 160) between them and historical opportunities with known outcomes. The distinction score is a unique metric that quantifies the degree of similarity or difference between each opportunity and the historical opportunities. This score is calculated using a proprietary algorithm that considers the shared variables (e.g., input variables 160), such as the nature of the case, the stage of litigation, the expected duration, the potential damages or settlement amounts, the financial health of the law firm, and the loan to value ratio. In some embodiments, the secure communication system is secured using a security token cached on a web browser (e.g., web browser 140), the web browser (e.g., web browser 140) providing the user-facing application.

According to some embodiments, advantageously, the use of a security token cached on a web browser (e.g., web browser 140) enhances the security of the system. The web browser (e.g., web browser 140) provides the user-facing application, which is the interface through which the first user inputs variables (e.g., input variables 160). The security token ensures that the user's session is secure, protecting the sensitive information involved in the litigation finance loan application process. This feature further addresses the problem of lack of security in the evaluation and comparison of litigation funding opportunities. In some embodiments, the secure communication system further comprises the data management system 185 and the predictive analytics system 155 located in secure isolation from a remainder of the secure communication system.

According to various embodiments, advantageously, the secure isolation of the data management system 185 and the predictive analytics system 155 from the remainder of the secure communication system further enhances the security of the system as shown in FIG. 1. This isolation prevents unauthorized access to the sensitive data and predictive analytics involved in the evaluation and comparison of litigation funding opportunities. This feature, combined with the use of a security token, provides a robust security framework for the secure communication system. In some embodiments, the first user is a legal entity, the legal entity having a portfolio of litigation cases.

According to some embodiments, advantageously, the secure communication system is designed to cater to legal entities with a portfolio of litigation cases. These entities could be law firms seeking litigation funding. The system allows these entities to securely input their case inventory, financial documents, and requested loan amount, which includes loan to value (LTV), into the system. The system then uses this information, along with litigation data, to evaluate and compare funding opportunities. This feature addresses the problem of lack of a uniform and secure application process for litigation finance loans, providing a solution that is tailored to the needs of legal entities. In some embodiments, the second user comprises an insurance entity, which may include one or more of an insurance provider, a reinsurance entity, a rating agency, and an insurance broker.

According to various embodiments, advantageously, the inclusion of an insurance entity as the second user broadens the scope of the secure communication system. The insurance entity could be an insurance provider, a reinsurance entity, a rating agency, or an insurance broker. This allows for a wider range of users to interact with the system, thereby increasing its utility. The insurance entity can provide valuable feedback loops, which can be used to adjust the evaluation scores. This feedback can be based on the insurance entity's risk threshold, which can be adjusted based on the evaluation scores. This feature allows for a dynamic and responsive system that can adapt to the needs of different users (e.g., end user(s) 105 (e.g., lawyers, investors, and insurers). In some embodiments, the secure communication system further comprises comparing the transformed evaluation scores to an insurance risk threshold. The first feedback loop from the insurance entity includes a decrease of the insurance risk threshold of the insurance entity. In response to the decrease of the insurance risk threshold, the updated evaluation scores are automatically converted to include at least one decreased updated evaluation score.

According to some embodiments, advantageously, the secure communication system's ability to compare transformed evaluation scores to an insurance risk threshold and adjust the scores based on feedback from the insurance entity enhances the system's adaptability. The system can automatically convert the updated evaluation scores to include at least one decreased updated evaluation score in response to a decrease in the insurance risk threshold. This feature allows the system to dynamically adjust to changes in the risk threshold of the insurance entity, thereby ensuring that the evaluation scores remain relevant and accurate. In some embodiments, the secure communication system further comprises comparing the transformed evaluation scores to an insurance risk threshold. The first feedback loop from the insurance entity includes an increase of the insurance risk threshold of the insurance entity. In response to the increase of the insurance risk threshold, the updated evaluation scores are automatically converted to include at least one increased updated evaluation score.

According to various embodiments, advantageously, the secure communication system's ability to adjust the evaluation scores in response to an increase in the insurance risk threshold of the insurance entity ensures that the system remains responsive to changes in the risk threshold. The system can automatically convert the updated evaluation scores to include at least one increased updated evaluation score in response to an increase in the insurance risk threshold. This feature allows the system to dynamically adjust to changes in the risk threshold of the insurance entity, thereby ensuring that the evaluation scores remain relevant and accurate. In some embodiments, the third user is an investment entity.

According to various embodiments, advantageously, the inclusion of an investment entity as the third user expands the range of users that can interact with the secure communication system. The investment entity can provide valuable feedback loops, which can be used to adjust the evaluation scores. This feedback can be based on the investment entity's risk threshold, which can be adjusted based on the evaluation scores. This feature allows for a dynamic and responsive system that can adapt to the needs of different users (e.g., end user(s) 105 (e.g., lawyers, investors, and insurers). In some embodiments, the secure communication system further comprises comparing the transformed evaluation scores to an investment risk threshold. The second feedback loop from the investment entity in response to providing the updated evaluation scores to the investment entity comprises a decrease of the investment risk threshold of the investment entity. In response to this, the updated evaluation scores are automatically converted to include at least one decreased transformed evaluation score.

According to various embodiments, advantageously, the secure communication system's ability to compare transformed evaluation scores to an investment risk threshold and adjust the scores based on feedback from the investment entity enhances the system's adaptability. The system can automatically convert the updated evaluation scores to include at least one decreased transformed evaluation score in response to a decrease in the investment risk threshold. This feature allows the system to dynamically adjust to changes in the risk threshold of the investment entity, thereby ensuring that the evaluation scores remain relevant and accurate. In some embodiments, the secure communication system further comprises comparing the transformed evaluation scores to an investment risk threshold. The second feedback loop from the investment entity in response to providing the updated evaluation scores to the investment entity comprises an increase of the investment risk threshold of the investment entity. In response to this, the updated evaluation scores are automatically converted to include at least one increased transformed evaluation score. Advantageously these embodiments provide a dynamic and responsive system for evaluating litigation funding opportunities. The system not only calculates evaluation scores based on input variables (e.g., input variables 160) and historical data, but also adjusts these scores in response to feedback from investment entities. This feedback loop allows the system to adapt to changes in the investment risk threshold of the investment entity, ensuring that the evaluation scores remain relevant and accurate. This feature addresses the problem of lack of a uniform and secure application process for litigation finance loans, as it provides a consistent and secure method for evaluating and comparing opportunities. The automatic conversion of evaluation scores in response to feedback also eliminates the need for manual recalculations, increasing the efficiency of the evaluation process.

In some embodiments, the input variables (e.g., input variables 160) from the first user comprise inputs from a law firm, such as an inventory of litigation cases, statement documents of the law firm, a requested loan amount, and a loan to value ratio (which is a comparison of the requested loan amount compared with collateral provided to secure the requested loan amount). Advantageously this embodiment allows for a comprehensive evaluation of litigation funding opportunities. The input variables (e.g., input variables 160) from the law firm provide a detailed picture of the potential opportunity, including the number and nature of litigation cases, the financial health of the law firm, and the requested loan amount and loan to value ratio. This information is crucial for evaluating the risk and potential return of the opportunity. The use of these specific input variables (e.g., input variables 160) also addresses the problem of lack of uniformity in the evaluation process, as it ensures that all opportunities are evaluated based on the same criteria in some instances.

In some embodiments, the plurality of opportunities comprise one or more of a lawsuit and an arbitration proceeding. Advantageously, this embodiment expands the scope of the secure communication system to include a variety of litigation funding opportunities. By including both lawsuits and arbitration proceedings in the plurality of opportunities, the system can cater to a wider range of legal entities and investment entities. This feature also addresses the problem of lack of a uniform and secure application process for litigation finance loans, as it provides a consistent and secure method for evaluating and comparing different types of opportunities.

In some embodiments, the set of variables (e.g., input variables 160) comprise one or more of a court docket item, a settlement, a verdict, and a legal update. Advantageously, this embodiment allows for a detailed and comprehensive evaluation of litigation funding opportunities. The inclusion of court docket items, settlements, verdicts, and legal updates in the set of variables (e.g., input variables 160) provides a wealth of information for evaluating the risk and potential return of the opportunity. This feature also addresses the problem of lack of a uniform and secure application process for litigation finance loans, as it ensures that all opportunities are evaluated based on the same criteria.

In some embodiments, the known outcomes comprise at least a known settlement amount. Advantageously, this embodiment provides a concrete basis for evaluating litigation funding opportunities. The known settlement amount serves as a benchmark for evaluating the potential return of the opportunity. This feature also addresses the problem of lack of a uniform and secure application process for litigation finance loans, as it provides a consistent and secure method for evaluating and comparing opportunities.

In some embodiments, the secure communication system comprises a distinction score for each of the plurality of opportunities that represents a degree of difference of the plurality of opportunities to one another and the historical opportunities. Advantageously, this embodiment provides a quantitative measure of the uniqueness of each opportunity. The distinction score allows for a more nuanced evaluation of opportunities, considering not only their potential return but also their similarity to other opportunities and historical opportunities. This feature also addresses the problem of lack of a uniform and secure application process for litigation finance loans, as it provides a consistent and secure method for evaluating and comparing opportunities.

In some embodiments, the secure communication system calculates evaluation scores that represent a range of values for each of the plurality of opportunities. Advantageously, this embodiment provides a flexible and nuanced method for evaluating litigation funding opportunities. The evaluation scores represent a range of potential outcomes for each opportunity, allowing for a more comprehensive assessment of risk and potential return. This feature also addresses the problem of lack of a uniform and secure application process for litigation finance loans, as it provides a consistent and secure method for evaluating and comparing opportunities.

In some embodiments, the secure communication system comprises a first feedback loop that receives real-time updates from an insurance entity. The processing using at least one processor to execute instructions stored in memory further comprises automatically converting, using at least one processor, the updated evaluation scores to real-time updated evaluation scores in response to the real-time updates from the insurance entity. Advantageously, the inclusion of a first feedback loop that receives real-time updates from an insurance entity enhances the dynamic nature of the secure communication system. The insurance entity could be an entity that provides insurance coverage for litigation cases. The real-time updates from the insurance entity could include changes in insurance coverage, changes in insurance premiums, and changes in the risk profile of the litigation cases. These updates are crucial as they can significantly impact the valuation of the litigation cases and, consequently, the evaluation scores. The system's processor automatically converts the updated evaluation scores to real-time updated evaluation scores in response to these real-time updates. This automatic conversion is performed using algorithms that consider the changes in the insurance entity's updates and their impact on the valuation of the litigation cases. This feature ensures that the evaluation scores are always up-to-date and accurately reflect the current status of the litigation cases, thereby facilitating a more accurate and efficient evaluation and comparison of litigation funding opportunities.

In some embodiments, the secure communication system further comprises receiving real-time updates from an investment entity. The processing using at least one processor to execute instructions stored in memory further comprises automatically converting, using at least one processor, and in response to the real-time updates from the investment entity, the transformed evaluation scores to real-time transformed evaluation scores. Advantageously, the secure communication system's ability to receive real-time updates from an investment entity further enhances its dynamic nature. The investment entity could be a hedge fund or a litigation finance company that provides funding for litigation cases. The real-time updates from the investment entity could include changes in investment strategies, changes in risk tolerance, and changes in the availability of funds. These updates are crucial as they can significantly impact the attractiveness of the litigation cases as investment opportunities and, consequently, the transformed evaluation scores. The system's processor automatically converts the transformed evaluation scores to real-time transformed evaluation scores in response to these real-time updates. This automatic conversion is performed using algorithms that take into account the changes in the investment entity's updates and their impact on the attractiveness of the litigation cases as investment opportunities. This feature ensures that the transformed evaluation scores are always up-to-date and accurately reflect the current investment landscape, thereby facilitating a more accurate and efficient evaluation and comparison of litigation funding opportunities.

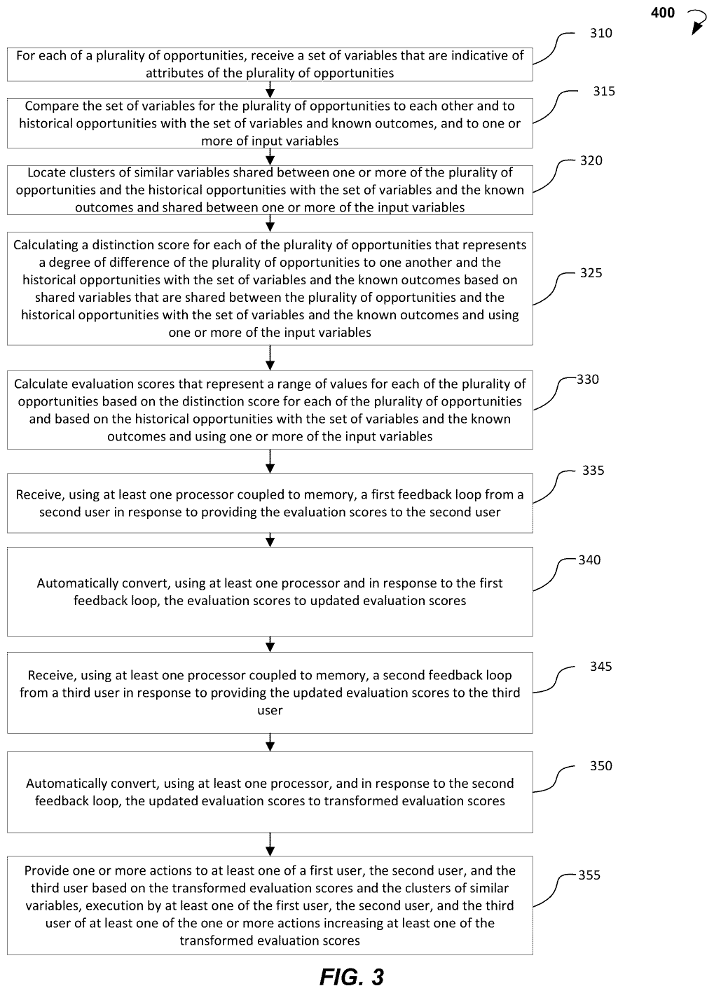

FIG. 3 is a flowchart of an example method 300 for according to the present technology. The method 300, may comprise the following operations. At step 310, for each of a plurality of opportunities, receive a set of variables (e.g., input variables 160) that are indicative of attributes of the plurality of opportunities. At step 315, compare the set of variables (e.g., input variables 160) for the plurality of opportunities to each other and to historical opportunities with the set of variables (e.g., input variables 160) and known outcomes, and to one or more of input variables (e.g., input variables 160). At step 320, locate clusters of similar variables (e.g., input variables 160) shared between one or more of the plurality of opportunities and the historical opportunities with the set of variables (e.g., input variables 160) and the known outcomes and shared between one or more of the input variables (e.g., input variables 160). At step 325, calculating a distinction score for each of the plurality of opportunities that represents a degree of difference of the plurality of opportunities to one another and the historical opportunities with the set of variables and the known outcomes based on shared variables that are shared between the plurality of opportunities and the historical opportunities with the set of variables and the known outcomes and using one or more of the input variables (e.g., input variables 160).

According to some embodiments, at step 330, calculate evaluation scores that represent a range of values for each of the plurality of opportunities based on the distinction score for each of the plurality of opportunities and based on the historical opportunities with the set of variables and the known outcomes and using one or more of the input variables (e.g., input variables 160). At step 335, receive, using at least one processor coupled to memory, a first feedback loop from a second user in response to providing the evaluation scores to the second user. At step 340, automatically convert, using at least one processor and in response to the first feedback loop, the evaluation scores to updated evaluation scores. At step 345, receive, using at least one processor coupled to memory, a second feedback loop from a third user in response to providing the updated evaluation scores to the third user. At step 350, automatically convert, using at least one processor, and in response to the second feedback loop, the updated evaluation scores to transformed evaluation scores. At step 355, provide one or more actions to at least one of a first user, the second user, and the third user based on the transformed evaluation scores and the clusters of similar variables, execution by at least one of the first user, the second user, and the third user of at least one of the one or more actions increasing at least one of the transformed evaluation scores.

FIG. 3 illustratively shows the method 300 according to the present technology according to various embodiments. The method includes receiving a set of variables (e.g., input variables 160) that are indicative of attributes of a plurality of opportunities, comparing the set of variables (e.g., input variables 160) for the plurality of opportunities to each other and to historical opportunities with the set of variables (e.g., input variables 160) and known outcomes, and to one or more input variables (e.g., input variables 160). Additionally, the method includes locating clusters of similar variables (e.g., input variables 160) shared between one or more of the plurality of opportunities and the historical opportunities with the set of variables (e.g., input variables 160) and known outcomes, calculating a distinction score for each of the plurality of opportunities that represents a degree of difference between them, calculating evaluation scores that represent a range of values for each opportunity based on the distinction score and using one or more input variables (e.g., input variables 160). Furthermore, the method includes receiving feedback loops from two users in response to providing evaluation scores and automatically converting these scores into updated evaluation scores and transformed evaluation scores. Finally, one or more actions are provided to at least one user based on these transformed evaluation scores and clusters of similar variables (e.g., input variables 160). Execution by at least one user increases at least one transformed evaluation score.

According to various embodiments, advantageously, this method 300 provides a uniform and secure process for evaluating and comparing litigation finance loan opportunities. The set of variables (e.g., input variables 160) received could include law firm inventory, financial documents of the law firm, and a requested loan amount, which includes loan to value (LTV), and litigation data. These variables are indicative of attributes of a plurality of opportunities, allowing for a comprehensive evaluation of each opportunity. The comparison of these variables to each other and to historical opportunities with known outcomes allows for a robust evaluation process that takes into account past trends and outcomes. The locating of clusters of similar variables shared between opportunities and historical opportunities further enhances the evaluation process by identifying patterns and similarities.

According to some embodiments, the calculation of distinction scores and evaluation scores provides a quantifiable measure of the value of each opportunity, facilitating the comparison process. The feedback loops from users and the automatic conversion of evaluation scores into updated and transformed scores allows for a dynamic and responsive evaluation process that adapts to user feedback. The provision of actions to users based on these scores and clusters of similar variables (e.g., input variables 160) allows for a tailored and personalized user experience. The execution of these actions by users increases the transformed evaluation scores, providing a measure of user engagement and real-time updates.

According to some embodiments, the method 300 addresses the problem of lack of a uniform and secure application process for litigation finance loans, providing a solution that is both secure and efficient. In some embodiments, the secure platform inputs include law firm inventory, the statement documents of the law firm, and a requested loan amount, the requested loan amount including loan to value (LTV), and litigation data.

According to various embodiments, advantageously, these secure platform inputs provide a comprehensive set of data for the evaluation and comparison of litigation finance loan opportunities. The inventory of the law firm could include all of the cases of the law firm, providing a detailed overview of the law firm's litigation matters. The statement documents of the law firm could include financial documents such as the last three years of tax returns for the law firm, statements of gross profits, expenses, net profit, overhead, case acquisition, court costs and filings, and expenses for experts. These documents provide a detailed financial profile of the law firm, facilitating the evaluation of the firm's financial stability and capacity to repay the loan. The requested loan amount, including loan to value (LTV), provides a measure of the law firm's funding needs and the value of their collateral. The litigation data provides additional context and information about the law firm's litigation matters. These inputs, when processed by the secure platform, allow for a thorough and comprehensive evaluation of each litigation finance loan opportunity, addressing the problem of lack of a uniform and secure application process.

In some embodiments, the secure communication system comprises at least one processor and a memory for storing executable instructions. The at least one processor executes the executable instructions to: receive a set of variables that are indicative of attributes of a plurality of opportunities; compare the set of variables for the plurality of opportunities to each other and to historical opportunities with the set of variables and known outcomes, and to one or more input variables (e.g., input variables 160); locate clusters of similar variables shared between one or more of the plurality of opportunities and the historical opportunities with the set of variables and known outcomes and shared between one or more input variables (e.g., input variables 160); calculate a distinction score for each of the plurality of opportunities that represents a degree of difference between them and the historical opportunities with the set of variables and known outcomes based on shared variables; calculate evaluation scores that represent a range of values for each opportunity based on the distinction score and using one or more input variables (e.g., input variables 160); receive feedback loops from two users in response to providing evaluation scores; automatically convert evaluation scores in response to feedback loops; calculate transformed evaluation scores; provide one or more actions to at least one user based on transformed evaluation scores and clusters of similar variables, execution by at least one user increasing at least one transformed evaluation score.

Advantageously according to some embodiments, the inclusion the communication platform including the secure communication system allows for the efficient and secure processing of data. The at least one processor receives a set of variables indicative of attributes of a plurality of opportunities. These variables could include law firm inventory, financial documents of the law firm, and a requested loan amount, which includes loan to value (LTV), and litigation data. The processor compares these variables to each other and to historical opportunities with known outcomes, and to one or more input variables (e.g., input variables 160). This comparison is facilitated by locating clusters of similar variables shared between the opportunities and the historical opportunities with known outcomes and shared between one or more input variables (e.g., input variables 160). This process allows for the calculation of a distinction score for each opportunity, representing a degree of difference between them and the historical opportunities based on shared variables. Evaluation scores are then calculated, representing a range of values for each opportunity based on the distinction score and using one or more input variables (e.g., input variables 160). Feedback loops from two users are received in response to providing evaluation scores, and these evaluation scores are automatically converted in response to the feedback loops. Transformed evaluation scores are then calculated, and one or more actions are provided to at least one user based on these transformed evaluation scores and clusters of similar variables. The execution of these actions by at least one user increases at least one transformed evaluation score. This process addresses the problem of lack of a uniform and secure application process for litigation finance loans, providing a solution that is efficient, secure, and tailored to the needs of legal entities.

According to various embodiments of the present technology, it will be understood that the term reinsurance as used herein may refer to a component or module within the secure communication system that is responsible for risk management, possibly through the distribution of risk across multiple entities, similar to the concept of reinsurance in the insurance industry.

According to various embodiments of the present technology, it will be understood that the term distinction score as used herein may refer to a calculated value that quantifies the uniqueness or difference of a particular set of variables in comparison to other sets within the secure communication system.

According to various embodiments of the present technology, it will be understood that the term transformed evaluation scores as used herein may refer to the updated and recalculated values of the initial evaluation scores after they have been processed through the system's predictive analytics, feedback loops, and automatic updates, which are then used to guide user actions within the secure communication system.

According to various embodiments of the present technology, it will be understood that the term investment risk threshold as used herein may refer to the maximum level of uncertainty or potential loss that an investor is willing to accept in relation to the evaluation scores and transformed evaluation scores generated by the secure communication system.

According to various embodiments of the present technology, it will be understood that the term court docket item as used herein may refer to a specific legal document or entry within a court's official record, related to the secure communication system, that is tracked, managed, and analyzed by the disclosed system for predictive analytics (e.g., predictive analytics system 155) and user interaction purposes.

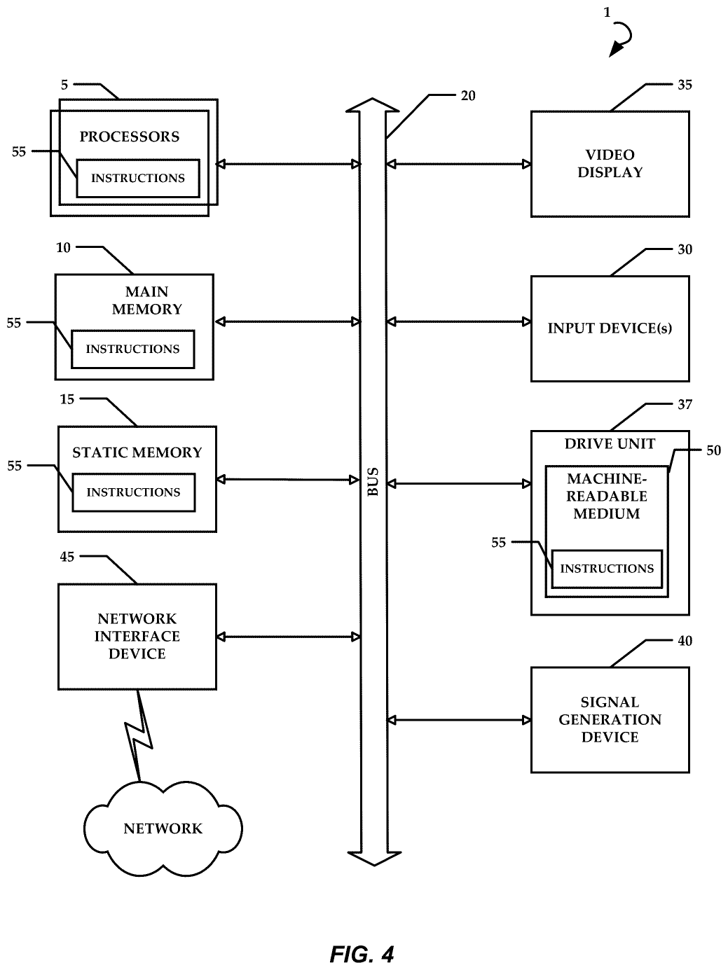

FIG. 4 illustrates an exemplary computing system that may be used to implement embodiments, according to various embodiments of the present technology. The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network (e.g., data network 110) via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices (e.g., client device(s) 120) that are coupled to the Internet service, and that the computing devices (e.g., client device(s) 120) may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A secure communication system configured by at least one processor to execute instructions stored in memory, the secure communication system comprising:
a user interface for receiving input variables from a first user;
a data management system comprising a database server for storing the input variables;
a predictive analytics system;
a platform providing a web services layer that provides access to the user interface, the data management system, and the predictive analytics system; the platform further providing an application server layer configured to:
provide a user-facing application using the user interface and access the data management system and the predictive analytics system using the web services layer;
perform processing using one or more of the input variables and user interaction with an evaluation application, the processing using at least one processor to execute instructions stored in memory to:
for each of a plurality of opportunities, receive a set of variables that are indicative of attributes of the plurality of opportunities;
compare the set of variables for the plurality of opportunities to each other and to historical opportunities with the set of variables and known outcomes, and to one or more of the input variables;
locate clusters of similar variables shared between one or more of the plurality of opportunities and the historical opportunities with the set of variables and the known outcomes and shared between one or more of the input variables;
calculating a distinction score for each of the plurality of opportunities that represents a degree of difference of the plurality of opportunities to one another and the historical opportunities with the set of variables and the known outcomes based on shared variables that are shared between the plurality of opportunities and the historical opportunities with the set of variables and the known outcomes and using one or more of the input variables;
calculate evaluation scores that represent a range of values for each of the plurality of opportunities based on the distinction score for each of the plurality of opportunities and based on the historical opportunities with the set of variables and the known outcomes and using one or more of the input variables;
receive, using at least one processor coupled to memory, a first feedback loop from a second user in response to providing the evaluation scores to the second user;
automatically convert, using at least one processor and in response to the first feedback loop, the evaluation scores to updated evaluation scores;
receive, using at least one processor coupled to memory, a second feedback loop from a third user in response to providing the updated evaluation scores to the third user;
automatically convert, using at least one processor, and in response to the second feedback loop, the updated evaluation scores to transformed evaluation scores; and
provide one or more actions to at least one of the first user, the second user, and the third user based on the transformed evaluation scores and the clusters of similar variables, execution by at least one of the first user, the second user, and the third user of at least one of the one or more actions increasing at least one of the transformed evaluation scores.

2. The secure communication system of claim 1, wherein the user-facing application is secured through use of a security token cached on a web browser, the web browser providing the user-facing application.

3. The secure communication system of claim 1, further comprising the data management system and the predictive analytics system are located in secure isolation from a remainder of the secure communication system.

4. The secure communication system of claim 1, wherein the first user is a legal entity, the legal entity having a portfolio of litigation cases.

5. The secure communication system of claim 1, wherein the second user comprises an insurance entity, the insurance entity comprising one or more of an insurance provider, a reinsurance entity, a rating agency, and an insurance broker.

6. The secure communication system of claim 5, further comprising comparing, by the insurance entity using at least one processor, the transformed evaluation scores to an insurance risk threshold;
wherein the first feedback loop from the insurance entity comprises a decrease of the insurance risk threshold of the insurance entity; and
automatically converting, in response to the decrease of the insurance risk threshold of the insurance entity, the updated evaluation scores to include at least one decreased updated evaluation score.

7. The secure communication system of claim 5, further comprising comparing, by the insurance entity using at least one processor, the transformed evaluation scores to an insurance risk threshold;
wherein the first feedback loop from the insurance entity comprises an increase of the insurance risk threshold of the insurance entity; and
automatically converting, in response to the increase of the insurance risk threshold of the insurance entity, the updated evaluation scores to include at least one increased updated evaluation score.

8. The secure communication system of claim 1, wherein the third user is an investment entity.

9. The secure communication system of claim 8, further comprising comparing, by the investment entity using at least one processor, the transformed evaluation scores to an investment risk threshold;
wherein the second feedback loop from the investment entity in response to providing the updated evaluation scores to the investment entity comprises a decrease of the investment risk threshold of the investment entity; and
automatically converting, in response to the decrease of the investment risk threshold of the investment entity, the updated evaluation scores to include at least one decreased transformed evaluation scores.

10. The secure communication system of claim 8, further comprising comparing, by the investment entity using at least one processor, the transformed evaluation scores to an investment risk threshold;
wherein the second feedback loop from the investment entity in response to providing the updated evaluation scores to the investment entity comprises an increase of the investment risk threshold of the investment entity; and
automatically converting, in response to the increase of the investment risk threshold of the investment entity, the updated evaluation scores to include at least one increased transformed evaluation scores.

11. The secure communication system of claim 1, wherein the input variables from the first user comprise inputs from a law firm, the inputs from the law firm comprising one or more of an inventory of litigation cases, statement documents of the law firm, a requested loan amount, a loan to value ratio, the loan to value ratio being a comparison of the requested loan amount compared with collateral provided to secure the requested loan amount.

12. The secure communication system of claim 1, wherein the plurality of opportunities comprise one or more of a lawsuit and an arbitration proceeding.

13. The secure communication system of claim 1, wherein the set of variables comprise one or more of a court docket item, a settlement, a verdict, and a legal update.

14. The secure communication system of claim 1, wherein the known outcomes comprises at least a known settlement amount.

15. The secure communication system of claim 1, wherein a distinction score for each of the plurality of opportunities that represents a degree of difference of the plurality of opportunities to one another and the historical opportunities comprises an evaluation tool for each opportunity of the plurality of opportunities.

16. The secure communication system of claim 1, wherein the evaluation scores represent a range of values for each of the plurality of opportunities.

17. The secure communication system of claim 1, wherein the first feedback loop comprises receiving real-time updates from an insurance entity; and
wherein the processing using at least one processor to execute instructions stored in memory to further comprises: in response to the real-time updates from the insurance entity, automatically convert, using at least one processor, the updated evaluation scores to real-time updated evaluation scores.

18. The secure communication system of claim 1, wherein the second feedback loop comprises receiving real-time updates from an investment entity; and
wherein the processing using at least one processor to execute instructions stored in memory to further comprises: in response to the real-time updates from the investment entity, automatically convert, using at least one processor, and in response to the real-time updates from the investment entity, the transformed evaluation scores to real-time transformed evaluation scores.

19. A method, comprising:
for each of a plurality of opportunities, receive a set of variables that are indicative of attributes of the plurality of opportunities;
compare the set of variables for the plurality of opportunities to each other and to historical opportunities with the set of variables and known outcomes, and to one or more of input variables;
locate clusters of similar variables shared between one or more of the plurality of opportunities and the historical opportunities with the set of variables and the known outcomes and shared between one or more of the input variables;
calculating a distinction score for each of the plurality of opportunities that represents a degree of difference of the plurality of opportunities to one another and the historical opportunities with the set of variables and the known outcomes based on shared variables that are shared between the plurality of opportunities and the historical opportunities with the set of variables and the known outcomes and using one or more of the input variables;
calculate evaluation scores that represent a range of values for each of the plurality of opportunities based on the distinction score for each of the plurality of opportunities and based on the historical opportunities with the set of variables and the known outcomes and using one or more of the input variables;
receive, using at least one processor coupled to memory, a first feedback loop from a second user in response to providing the evaluation scores to the second user;
automatically convert, using at least one processor and in response to the first feedback loop, the evaluation scores to updated evaluation scores;
receive, using at least one processor coupled to memory, a second feedback loop from a third user in response to providing the updated evaluation scores to the third user;
automatically convert, using at least one processor, and in response to the second feedback loop, the updated evaluation scores to transformed evaluation scores; and
provide one or more actions to at least one of a first user, the second user, and the third user based on the transformed evaluation scores and the clusters of similar variables, execution by at least one of the first user, the second user, and the third user of at least one of the one or more actions increasing at least one of the transformed evaluation scores.

20. A secure communication system of claim, comprising:
at least one processor; and
a memory for storing executable instructions, the at least one processor executing the executable instructions to:
for each of a plurality of opportunities, receive a set of variables that are indicative of attributes of the plurality of opportunities;
compare the set of variables for the plurality of opportunities to each other and to historical opportunities with the set of variables and known outcomes, and to one or more of input variables;
locate clusters of similar variables shared between one or more of the plurality of opportunities and the historical opportunities with the set of variables and the known outcomes and shared between one or more of the input variables;
calculating a distinction score for each of the plurality of opportunities that represents a degree of difference of the plurality of opportunities to one another and the historical opportunities with the set of variables and the known outcomes based on shared variables that are shared between the plurality of opportunities and the historical opportunities with the set of variables and the known outcomes and using one or more of the input variables;
calculate evaluation scores that represent a range of values for each of the plurality of opportunities based on the distinction score for each of the plurality of opportunities and based on the historical opportunities with the set of variables and the known outcomes and using one or more of the input variables;
receive, using at least one processor coupled to memory, a first feedback loop from a second user in response to providing the evaluation scores to the second user;
automatically convert, using at least one processor and in response to the first feedback loop, the evaluation scores to updated evaluation scores;
receive, using at least one processor coupled to memory, a second feedback loop from a third user in response to providing the updated evaluation scores to the third user;
automatically convert, using at least one processor, and in response to the second feedback loop, the updated evaluation scores to transformed evaluation scores; and
provide one or more actions to at least one of a first user, the second user, and the third user based on the transformed evaluation scores and the clusters of similar variables, execution by at least one of the first user, the second user, and the third user of at least one of the one or more actions increasing at least one of the transformed evaluation scores.
